(19) United States
(12) Patent Application Publication
(10) Pub. No.: US 2005/0219560 A1
(43) Pub. Date: Oct. 6, 2005

(54) Methods and systems for processing documents of a production run

(76) Inventor: James C. Bratnober, Boise, ID (US)

Correspondence Address: HEWLETT-PACKARD COMPANY;Intellectual Property Administration, P. O. Box 272400, Fort Collins, CO, 80527-2400, US

(21) Appl. No.: 11/029,084

(22) Filed: Jan. 4, 2005

Related U.S. Application Data
(60) Provisional application No. 60/559,880, filed on Apr. 5, 2004.

(51) Int. Cl. G06F 15/00

(52) U.S. Cl. 358/1.5

(57) ABSTRACT

Methods and systems for processing documents of a production run are described. In one embodiment, a method comprises receiving pages of one or more documents of a production run in a print environment; and applying individual machine-readable identifiers to individual pages of the production run, the individual identifiers containing information that is unique to the page and the document of which the page is a part, individual identifiers being human-viewable but not human readable.

### RELATED APPLICATION

This application claims the benefit of a related U.S. Provisional Application Ser. No. 60/559,880 filed Apr. 5, 2004 entitled “Methods and Systems for Processing Documents of a Production Run” to Bratnober, the disclosure of which is incorporated by reference herein.

### BACKGROUND

Production print environments are typically environments in which large numbers of documents are printed. Many times, production print environments are larger, industrial-type printing environments in which production runs of multiple copies of documents having many pages are conducted. For example, it is not unusual in the larger, industrial-type printing environments to have a production run of 10,000 copies of a 100-page document.

In a production print environment, there are usually multiple stations at which various operations are conducted. For example, there can be a receiving station that receives that raw media that is to be printed upon, a printing station that prints upon the media, and one or more stations associated with organizing the media into the final document. These other stations can include a drilling station for drilling the media, a binding station for binding the media into a document, and a packaging station for packaging the bound documents.

In production print environments there are any number of ways that the pages of a document can get out of order. For example, in in-line or near-line printing systems, as the media is moved from station to station, a paper jam can occur or pages can be mutilated or otherwise become separated from the particular copy of the document in which the page is to reside. Additionally, human error can cause pages of a print run to lose their order. For example, in very large production runs, it is not uncommon for a fork lift to be used to transport large numbers of documents from, for example, the drilling station to the binding station. If, for some reason, the fork lift operator mishandles the documents during transport, the documents can fall off of the fork lift and become mixed together.

In situations like these and others, the common approach is to manually attempt to place all of the pages back in their original order. Needless to say, this is an exhausting and manually intensive process. In addition, an additional level of complexity is imposed in situations where all of the documents of a production run are not identical. For example, in some production runs, it may be desirable to customize 100 copies of a 10,000 copy run with unique information. If the pages of this production run become disarrayed, then not only does the individual attempting to reorder the pages have to identify the individual pages of each document, they also have to identify the 100 customized copies of the production run. Needless to say, this is a daunting task.

### SUMMARY

In one embodiment, a method comprises receiving pages of one or more documents of a production run in a print environment; and applying individual machine-readable identifiers to individual pages of the production run, the individual identifiers containing information that is unique to the page and the document of which the page is a part, individual identifiers being human-viewable but not human readable.

### BRIEF DESCRIPTION OF THE DRAWINGS

FIG. 1 is a block diagram of an exemplary production print environment.

FIG. 2 is a flow diagram that describes a method in accordance with one embodiment.

FIG. 2a shows an exemplary page and identifier in accordance with one embodiment.

FIG. 3 is a block diagram of an exemplary production print environment in accordance with one embodiment.

FIG. 4 is a block diagram of an exemplary production print environment in accordance with one embodiment.

FIG. 5 is a block diagram of an exemplary production print environment in accordance with one embodiment.

### DETAILED DESCRIPTION

Overview

Methods and systems are described in which information in the form of an identifier is provided onto pages of one or more documents in a production run of a production print environment. The identifier can provide page-unique and document-unique information that can be utilized in the production run. For example, the identifiers can be utilized to proactively guide the production run and/or to reactively recover from mishaps in the production environment, e.g. inadvertent page reordering cause by spillage.

Exemplary Production Print Environment

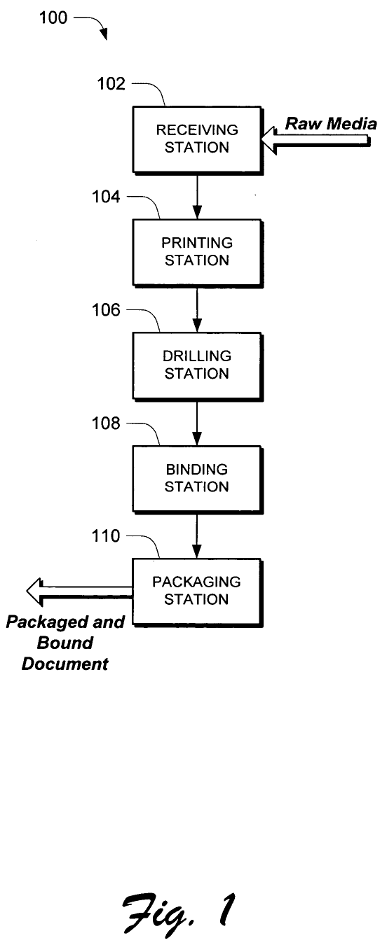

In accordance with one embodiment, the inventive principles described herein can be employed in the context of a production print environment. Exemplary production print environments can be characterized by one or more stations that are designed to accomplish some task that is associated with the printing process. As an example, consider FIG. 1 which shows an exemplary production print environment generally at 100.

In this particular example, environment 100 comprises a receiving station 102 for receiving the raw media that is to be printed upon, a printing station 104 for printing on the raw media, a drilling station 106 for drilling the media after the media is printed upon, a binding station 108 for binding individual documents of the production run, and finally a packaging station 110 for packaging bound documents so that the documents can be shipped to their ultimate destination.

As noted above, various embodiments described below can be employed proactively to guide the production run and/or to reactively recover from mishaps in the production environment.

Exemplary Characteristics of Identifiers

In accordance with the described embodiments, pages of documents within a production run are marked with an identifier that can provide page-unique and document-unique information that can be utilized in the production run. For example, the page-unique information can comprise the page number of the particular page and the document-unique information can comprise an associated document number of the document of which the page is a part. As an example, consider the following. Assume that a particular production run is to produce 10,000 documents each having 300 pages. In this particular instance, the identifier can include the document number and the page number, e.g. Document #2532, page 250. In accordance with one embodiment, each and every page of every document can carry its own unique identifier.

Alternately or additionally, in some embodiments other information can be embodied by the identifier. For example, some pages of a production run may require unique finishing. In these instances, the identifier can indicate finishing directions and can thus guide the production run.

In accordance with the embodiments described herein, the identifier is a machine-readable identifier. This can enable one or more machines or devices to read the identifier and use it in some way. For example, a dedicated sorting machine can be used to read page identifiers and automatically sort and reorder the pages in the event the pages of the production run become disordered. Alternately or additionally, various machines within the printing environment can be configured with a reading mechanism, such as a scanner, to read identifiers and verify the integrity of the production run as the documents are processed through the various stations.

In accordance with one embodiment, the identifiers are human-viewable, but not human readable. That is, the identifiers can be viewed or perceived by a human, but the content or meaning of the identifier is not discernable by a human. For example, a page number is both human viewable and human readable. A bar code, on the other hand, is human viewable but not human readable. Alternately or additionally, the identifier may be encrypted in some manner thus rendering it unreadable for content by a human, yet viewable to the unaided eye.

In addition, in some embodiments, the identifier may be human viewable in that it is printed upon a page, but not readily or immediately identifiable or readable by a human. For example, the identifier may be hidden at some location on the page such that it is not readily apparent that the page bears any identifier at all. Yet, to a machine that is configured to ascertain the identifier, it is readily identifiable by the machine. In these embodiments, the identifier can be considered as a steganographic identifier that is embedded on pages of the document.

In yet other embodiments, the identifier can be machine-readable, but not human-viewable. For example, the identifier can be printed with an ink that is not viewable to the unaided human eye, yet is discernable only with a specially-configured scanner, e.g. an infrared scanner.

The identifier might also be rendered without utilizing ink. For example, a small area of a page might be embossed or otherwise marked with an identifier.

Specific Implementation Example

In one embodiment, a bar code can be utilized to provide identifiers on pages of the documents of a print run. Any suitable bar code can be utilized. For example, 1-dimensional bar codes, multi-dimensional (e.g. 2-dimensional) bar codes, or combinations thereof can be utilized.

A 1-dimensional bar code is a bar code in which information is extracted using an optical scanner. Information is encoded across one dimension of the bar code. Typically, the information is encoded along the length of the bar code by virtue of the dimensions of the black bars and white spaces between the black bars, as will be appreciated by the skilled artisan.

2-dimensional bar code stores information along both the height of the bar code as well as the length of the bar code. 2-dimensional bar codes can be utilized in scenarios where only a small amount of space is available for the bar code.

In some embodiments, the identifier can be provided by combining 1-dimensional and 2-dimensional bar codes. One example of how 1- and 2-dimensional bar codes can be combined is described in U.S. Pat. No. 6,398,117 to Oakeson, assigned to the assignee of this document, the disclosure of which is incorporated by reference herein.

Exemplary Method

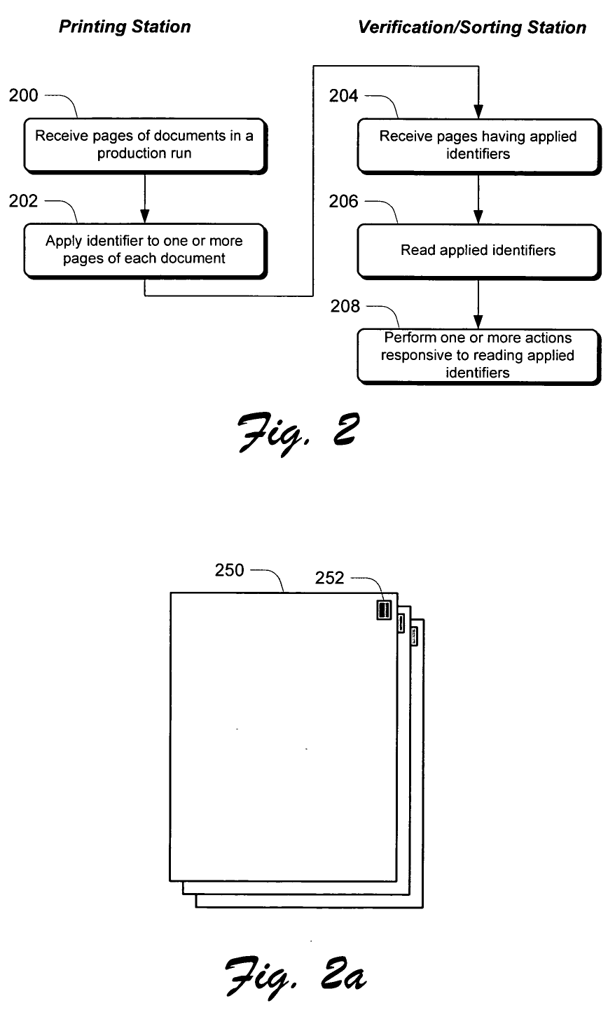

FIG. 2 is a flow diagram that describes a method in accordance with one embodiment. In the illustrated example, the method of FIG. 2 is divided into two columns-a first of which labeled “Printing Station” and a second of which labeled “Verification/Sorting Station”. This is done to illustrate, in accordance with one embodiment, the entities that perform the acts described just below.

Step 200 receives pages of documents that are the subject of a production run in a production print environment. In the described embodiment, this step can be performed by a printing station, such as printing station 104 in FIG. 1. Step 202 applies an identifier to one or more pages of each document in the production run. This step can be accomplished by the printing station by, for example printing the identifier on the page(s). Alternately, this step can be accomplished by a different component that is configured to apply the identifier to the page(s). For example, the identifier may comprise a type of material other than the ink or toner that is utilized to print the actual content of the documents. In this case, a separate component may be specially configured to apply the identifier to the document. An exemplary document having multiple pages and identifiers is shown in FIG. 2a. There, a single page 250 is shown to have an identifier 252.

Step 204 receives pages having the applied identifiers. This step can be performed by one or more verification stations that might be associated with individual stations within the printing environment. In this instance, the verification stations can be used to proactively guide the printing process. Alternately or additionally, this step can be performed by a special sorting station that is specifically designed to reactively recover from a printing mishap. Examples of both the proactive and reactive scenarios are provided below. Step 206 reads the applied identifiers. This step can be performed by specifically identifying the location on the page in which the identifier resides and then reading the identifier through, for example, scanning or otherwise ascertaining the content of the identifier in a machine-readable manner.

Step 208 performs one or more actions responsive to reading the applied identifier. Any suitable action can be performed. For example, in embodiments in which the identifier is proactively used to guide the printing process, such actions can include verifying the integrity of the individual documents, notifying upstream or downstream components of actions that are to be taken or taking specific actions (e.g. notifying a finishing station of finishing instructions or following the finishing instructions that are embodied on the identifier). Alternately or additionally, in embodiments in which the identifier is used to reactively recover from a mishap, such actions can involve automatically sorting and re-ordering the documents to recover from the mishap.

Exemplary Environment in Which Identifier is Used Proactively

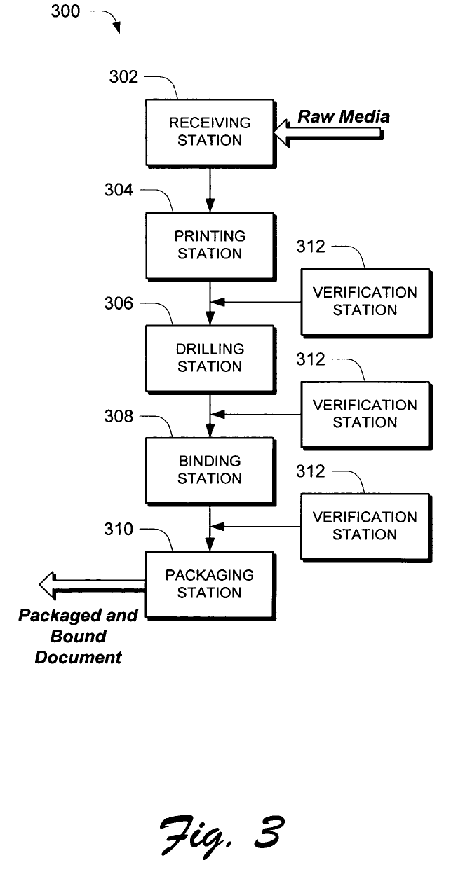

FIG. 3 shows an embodiment of a printing environment 300 in accordance with one embodiment. In this example, like numerals have been utilized from the FIG. 1 example to depict similar stations, except that designators having the form “1XX” have been replaced with designators having the “3XX” form. In this embodiment, multiple different verification stations 312 are provided. In this particular example, a verification station 312 is provided at the output of the printing station 304, the drilling station 306 and the binding station 308. In this embodiment, verification stations are utilized to read the applied identifiers and verify the integrity of the documents of the print run. Although the verification stations are depicted as separate components, the verification stations can be integrated into the components that comprise a particular station.

Exemplary Environment in Which Identifier is Used Reactively

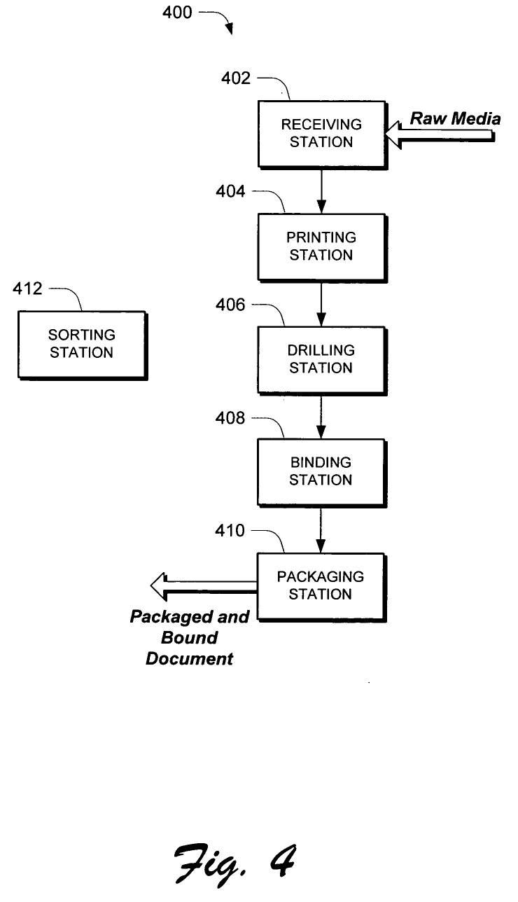

FIG. 4 shows an embodiment of a printing environment 400 in accordance with one embodiment. In this example, like numerals have been utilized from the FIG. 1 example to depict similar stations, except that designators having the form “1XX” have been replaced with designators having the “4XX” form. In this embodiment, a sorting station 412 is provided. In this particular example, sorting station 412 is provided to facilitate recovering from a printing mishap in which the pages of a print run become disordered. In this embodiment, the sorting station is utilized to read the applied identifiers and automatically sort and reorder the pages of the documents of the print run.

Exemplary Environment in Which Identifier is Used Proactively and Reactively

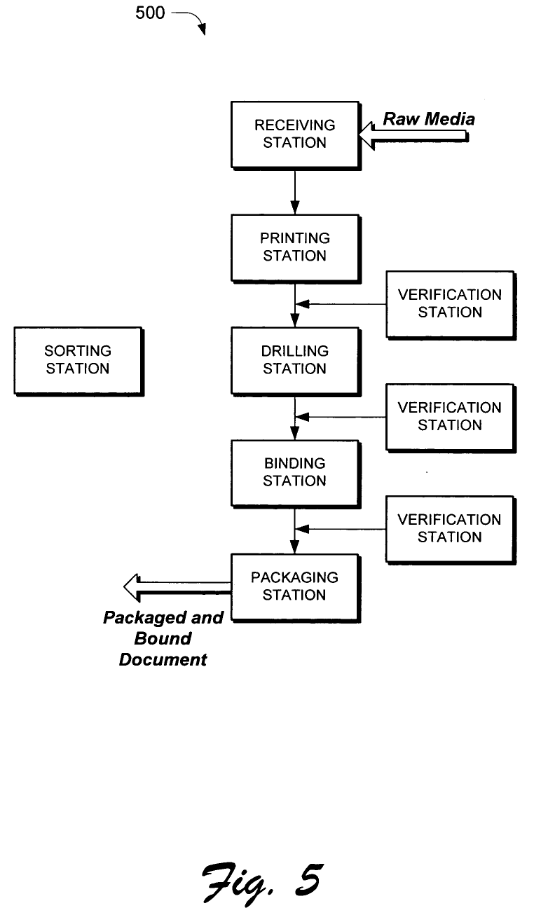

In accordance with one embodiment, the printing environment can have both verification and sorting stations. An example of one such environment is shown in FIG. 5 at 500.

### CONCLUSION

Methods and systems described above provide information in the form of an identifier that is applied on pages of one or more documents in a production run. The identifier can provide page-unique and document-unique information, as well as other information that can be utilized in the production run. In various embodiments, the identifiers can be utilized to proactively guide the production run and/or to reactively recover from mishaps in the production environment. The identifiers impart to the production process a degree of automation that can save money and time associated with production runs.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
receiving pages of one or more documents of a production run in a print environment; and
applying individual machine-readable identifiers to individual pages of the production run, the individual identifiers containing information that is unique to the page and the document of which the page is a part, individual identifiers being human-viewable but not human readable.

2. The method of claim 1, wherein said identifier further comprises information that can guide the production run.

3. The method of claim 1, wherein said information comprises a page number and a document number.

4. The method of claim 1, wherein said act of applying is performed on each page of a document in the production run.

5. The method of claim 1, wherein said identifiers comprise a one-dimensional bar code.

6. The method of claim 1, wherein said identifiers comprise a two-dimensional bar code.

7. The method of claim 1, wherein said identifiers comprise a combined one-dimensional and two-dimensional bar code.

8. The method of claim 1, wherein the act of applying is performed by a printing station comprising part of the print environment.

9. A method comprising:
receiving pages of one or more documents of a production run in a print environment; and
applying individual machine-readable identifiers to individual pages of the production run, the individual identifiers containing information that is unique to the page and the document of which the page is a part, individual identifiers not being human readable.

10. The method of claim 9, wherein said identifier further comprises information that can guide the production run.

11. The method of claim 9, wherein said information comprises a page number and a document number.

12. The method of claim 9, wherein said act of applying is performed on each page of a document in the production run.

13. The method of claim 9, wherein the act of applying is performed by a printing station comprising part of the print environment.

14. A method comprising:
receiving pages of one or more documents of a production run in a print environment;
applying individual machine-readable identifiers to individual pages of the production run, the individual identifiers containing information that is unique to the page and the document of which the page is a part, individual identifiers not being human-viewable.

15. The method of claim 14, wherein said identifier further comprises information that can guide the production run.

16. The method of claim 14, wherein said information comprises a page number and a document number.

17. The method of claim 14, wherein said act of applying is performed on each page of a document in the production run.

18. The method of claim 14, wherein the act of applying is performed by a printing station comprising part of the print environment.

19. A method comprising:
receiving pages of one or more documents of a production run in a print environment; and
applying individual machine-readable identifiers to individual pages of the production run, the individual identifiers containing information that is unique to the page and the document of which the page is a part, individual identifiers not being human-viewable or human readable.

20. The method of claim 19, wherein said identifier further comprises information that can guide the production run.

21. The method of claim 19, wherein said information comprises a page number and a document number.

22. The method of claim 19, wherein said act of applying is performed on each page of a document in the production run.

23. The method of claim 19, wherein the act of applying is performed by a printing station comprising part of the print environment.

24. A method comprising:
receiving pages of one or more documents of a production run in a print environment, the one or more pages having applied thereon individual machine-readable identifiers, the individual identifiers containing information that is unique to the page and the document of which the page is a part, individual identifiers being human-viewable but not human readable;
reading the applied identifiers; and
performing one or more actions responsive to reading the applied identifiers.

25. The method of claim 24, wherein said identifier further comprises information that can guide the production run.

26. The method of claim 24, wherein said information comprises a page number and a document number.

27. The method of claim 24, wherein each page of a document in the production run comprises an identifier.

28. The method of claim 24, wherein said identifiers comprise a one-dimensional bar code.

29. The method of claim 24, wherein said identifiers comprise a two-dimensional bar code.

30. The method of claim 24, wherein said identifiers comprise a combined one-dimensional and two-dimensional bar code.

31. The method of claim 24, wherein said act of reading is performed by one or more of a printing station, drilling station, and binding station.

32. The method of claim 24, wherein said act of reading is performed by a sorting station.

33. The method of claim 24, wherein said act of reading is performed by tow or more of a printing station, a drilling station, a binding station and a sorting station.

34. The method of claim 24, where said act of performing comprises verifying the integrity of individual documents.

35. The method of claim 24, wherein said act of performing comprises automatically sorting and re-ordering pages of the documents.

36. A method comprising:
receiving pages of one or more documents of a production run in a print environment, the one or more pages having applied thereon individual machine-readable identifiers, the individual identifiers containing information that is unique to the page and the document of which the page is a part, individual identifiers not being human-readable;
reading the applied identifiers; and
performing one or more actions responsive to reading the applied identifiers.

37. The method of claim 36, wherein said identifier further comprises information that can guide the production run.

38. The method of claim 36, wherein said information comprises a page number and a document number.

39. The method of claim 36, wherein each page of a document in the production run comprises an identifier.

40. The method of claim 36, wherein said act of reading is performed by one or more of a printing station, drilling station, and binding station.

41. The method of claim 36, wherein said act of reading is performed by a sorting station.

42. The method of claim 36, wherein said act of reading is performed by two or more of a printing station, a drilling station, a binding station and a sorting station.

43. The method of claim 36, wherein said act of performing comprises verifying the integrity of individual documents.

44. The method of claim 36, wherein said act of performing comprises automatically sorting and re-ordering pages of the documents.

45. A method comprising:
receiving pages of one or more documents of a production run in a print environment, the one or more pages having applied thereon individual machine-readable identifiers, the individual identifiers containing information that is unique to the page and the document of which the page is a part, individual identifiers not being human-viewable;
reading the applied identifiers; and
performing one or more actions responsive to reading the applied identifiers.

46. The method of claim 45, wherein said identifier further comprises information that can guide the production run.

47. The method of claim 45, wherein said information comprises a page number and a document number.

48. The method of claim 45, wherein each page of a document in the production run comprises an identifier.

49. The method of claim 45, wherein said act of reading is performed by one or more of a printing station, drilling station, and binding station.

50. The method of claim 45, wherein said act of reading is performed by a sorting station.

51. The method of claim 45, wherein said act of reading is performed by two or more of a printing station, a drilling station, a binding station and a sorting station.

52. The method of claim 45, wherein said act of performing comprises verifying the integrity of individual documents.

53. The method of claim 45, wherein said act of performing comprises automatically sorting and re-ordering pages of the documents.

54. A method comprising:
receiving pages of one or more documents of a production run in a print environment, the one or more pages having applied thereon individual machine-readable identifiers, the individual identifiers containing information that is unique to the page and the document of which the page is a part, individual identifiers not being human-readable or human-viewable;
reading the applied identifiers; and
performing one or more actions responsive to reading the applied identifiers.

55. The method of claim 54, wherein said identifier further comprises information that can guide the production run.

56. The method of claim 54, wherein said information comprises a page number and a document number.

57. The method of claim 54, wherein each page of a document in the production run comprises an identifier.

58. The method of claim 54, wherein said act of reading is performed by one or more of a printing station, drilling station, and binding station.

59. The method of claim 54, wherein said act of reading is performed by a sorting station.

60. The method of claim 54, wherein said act of reading is performed by two or more of a printing station, a drilling station, a binding station and a sorting station.

61. The method of claim 54, wherein said act of performing comprises verifying the integrity of individual documents.

62. The method of claim 54, wherein said act of performing comprises automatically sorting and re-ordering pages of the documents.

63. A system comprising:
means for receiving pages of one or more documents of a production run in a print environment; and
means for applying individual machine-readable identifiers to individual pages of the production run, the individual identifiers containing information that is unique to the page and the document of which the page is a part, individual identifiers being human-viewable but not human readable.

64. The system of claim 63, wherein said means for applying comprises a printing station comprising part of the print environment.

65. A system comprising:
means for receiving pages of one or more documents of a production run in a print environment; and
means for applying individual machine-readable identifiers to individual pages of the production run, the individual identifiers containing information that is unique to the page and the document of which the page is a part, individual identifiers not being human-readable.

66. The system of claim 65, wherein said means for applying comprises a printing station comprising part of the print environment.

67. A system comprising:
means for receiving pages of one or more documents of a production run in a print environment; and
means for applying individual machine-readable identifiers to individual pages of the production run, the individual identifiers containing information that is unique to the page and the document of which the page is a part, individual identifiers not being human-viewable.

68. The system of claim 67, wherein said means for applying comprises a printing station comprising part of the print environment.

69. A system comprising:
means for receiving pages of one or more documents of a production run in a print environment; and
means for applying individual machine-readable identifiers to individual pages of the production run, the individual identifiers containing information that is unique to the page and the document of which the page is a part, individual identifiers not being human-readable or human-viewable.

70. The system of claim 69, wherein said means for applying comprises a printing station comprising part of the print environment.

71. A system comprising:
a document having multiple pages;
individual pages having embodied thereon machine-readable identifiers that contain information that is unique to the page and the document of which the page is a part;
individual identifiers being human-viewable but not human readable; and
individual identifiers being configured to be used to reorder pages of the document in an event the pages become disarrayed.

72. The system of claim 71, wherein said identifiers comprise a one-dimensional bar code.

73. The system of claim 71, wherein said identifiers comprise a one-dimensional bar code, and wherein said information comprises a page number and a document number.

74. The system of claim 71, wherein said identifiers comprise a one-dimensional bar code, and wherein said information comprises a page number and a document number, wherein said information further comprises information that can guide a production run that printed the document.

75. The system of claim 71, wherein said identifiers comprise a two-dimensional bar code.

76. The system of claim 71, wherein said identifiers comprise a two-dimensional bar code, wherein said information comprises a page number and a document number.

77. The system of claim 71, wherein said identifiers comprise a two-dimensional bar code, wherein said information comprises a page number and a document number, and wherein said information further comprises information that can guide a production run that printed the document.

78. The system of claim 71, wherein said identifiers comprise a combined one-dimensional and two-dimensional bar code.

79. The system of claim 71, wherein said identifiers comprise a combined one-dimensional and two-dimensional bar code, wherein said information comprises a page number and a document number.

80. The system of claim 71, wherein said identifiers comprise a combined one-dimensional and two-dimensional bar code, wherein said information comprises a page number and a document number, wherein said information further comprises information that can guide a production run that printed the document.
